(19) United States
(12) Patent Application Publication
(10) Pub. No.: US 2007/0257614 A1
(43) Pub. Date: Nov. 8, 2007

(54) Plasma display panel

(76) Inventors: Seung-Uk Kwon, Suwon-si (KR); Tae-Woong Jang, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/634,729

(22) Filed: Dec. 6, 2006

(30) Foreign Application Priority Data
May 4, 2006 (KR) 10-2006-0040403

(51) Int. Cl. H01J 17/49

(52) U.S. Cl. 313/582

(57) ABSTRACT

Provided is a plasma display panel in which the capacitances of all discharge cells are substantially the same and the same firing voltage is applied to the discharge cells, thereby preventing an overdischarge from occurring therein and reducing the firing voltage. The plasma display panel includes a first substrate, a second substrate located to face the first substrate at a predetermined distance from the first substrate, a barrier rib structure located between the first and second substrates to define discharge cells in which a gas discharge occurs, pairs of discharge electrodes each including an X electrode and an Y electrode which extend across the discharge cells, address electrodes extending across the discharge cells to intersect the discharge electrodes in the discharge cells, and phosphor layers each being applied onto one of the discharge cells and formed of one of red, green, and blue emitting phosphors. Here, the thicknesses of the red, green, and blue phosphor layers which are respectively formed in the discharge cells are different from one another.

### CROSS-REFERENCE TO RELATED PATENT APPLICATION

This application claims the priority of Korean Patent Application No. 10-2006-0040403, filed on May 4, 2006, in the Korean Intellectual Property Office, the disclosure of which is incorporated herein in its entirety by reference.

### BACKGROUND OF THE INVENTION

1. Field of the Invention

The present embodiments relate to a plasma display panel, and more particularly, to a plasma display panel having an improved phosphor layer structure.

2. Description of the Related Art

Plasma display panels, which display an image by excitation of phosphor using ultraviolet rays generated by a gas discharge, are considered to be the next-generation display devices due to the possibility to manufacture them using high-definition, large screens.

A plasma display panel includes a first substrate and a second substrate that face each other and are spaced apart a predetermined distance, a barrier rib structure that divides a space between the first and second substrates into a plurality of discharge cells, a liquid that is injected into the discharge cells to generate a discharge therein, phosphors respectively formed in the discharge cells, and a plurality of electrodes to which a voltage is applied.

In order to display an image in a three-electrode surface discharge plasma display panel, discharge cells must be selected by accumulating a predetermined amount of electric charges in a barrier rib structure, which defines the discharge cells, and generating a gas discharge in each selected discharge cell located at a point where an address electrode and a scan electrode intersects each other by applying a voltage between the address electrode and the scan electrode.

The voltage applied between the intersecting address electrode and scan electrode is affected by the capacitances of the address electrode and the scan electrode.

However, intersecting electrodes in the plasma display panel are not generally coated with the same material in all of the discharge cells. Accordingly, in order to generate a gas discharge, a different voltage is applied between the intersecting address electrode and scan electrode in each of the discharge cells.

For example, in a three-electrode surface discharge plasma display panel, the capacitance of a scan electrode on a first substrate is formed by a dielectric layer and a protective layer deposited to cover the scan electrode, and the capacitance of an address electrode on a second substrate is formed by a dielectric layer and a protective layer deposited to cover the address electrode. Here, each of the dielectric layer and the protective layer covering the scan electrode or the address electrode is formed of the same material in all discharge cells. However, different phosphors are applied onto the address electrode, that is, red, green and blue phosphors are respectively applied onto the discharge cells. Accordingly, the capacitances of the discharge cells corresponding to the address electrode covered with different phosphors are different from one another since the different phosphors have different permittivities, densities, diameters, thicknesses, and shapes.

For this reason, the overall capacitances of the red, green, and blue discharge cells are different from one another, and thus, different firing voltages are needed to be applied to the red, green, and blue discharge cells. Thus, conventionally, in order to generate a gas discharge in all of the discharge cells, the highest firing voltage of the firing voltages is applied to all of the discharge cells.

However, an overdischarge can occur in other discharge cells except a discharge cell requiring the highest firing voltage. As a result, electric charges are consumed without being accumulated, and an error in a discharge occurs. Also, the use of the highest firing voltage increases power consumption, thereby degrading the efficiency of the plasma display panel.

### SUMMARY OF THE INVENTION

The present embodiments provide a plasma display panel in which the capacitances of all discharge cells are substantially the same and the same firing voltage is applied to all discharge cells, thereby preventing an overdischarge from occurring in the discharge cell and reducing the firing voltage.

According to an aspect of the present embodiments, there is provided a plasma display panel comprising a first substrate; a second substrate located to face the first substrate at a predetermined distance from the first substrate; a barrier rib structure located between the first and second substrates to define discharge cells in which a gas discharge occurs; pairs of discharge electrodes each including an X electrode and an Y electrode which extend across the discharge cells; address electrodes extending across the discharge cells to intersect the discharge electrodes in the discharge cells; and phosphor layers each being applied onto one of the discharge cells and formed of one of red, green, and blue emitting phosphors, wherein the thicknesses of the red, green, and blue phosphor layers which are respectively formed in the discharge cells are different from one another.

The capacitances of the red, green, and blue emitting phosphor layers may be substantially the same.

When the permittivity of one of the red, green, and blue emitting phosphor layers is greater than the permittivities of the others, the thickness of the red, green, or blue emitting phosphor layer which has the greatest permittivity may be thicker than the thicknesses of the others.

The thicknesses of the red, green, and blue emitting phosphor layers may be in a ratio of 1:0.7 to 0.9:1.1 to 1.3.

The thicknesses of the red, green, and blue emitting phosphor layers may be in a ratio of 1:0.83:1.22.

The red emitting phosphor may comprise at least one selected from the group consisting of Y₂O₃:Eu³⁺, Y(V,P)O₄:Eu³⁺ and (Y,Gd)BO₃:Eu³⁺.

The green emitting phosphor may comprise at least one selected from the group consisting of Zn₂SiO₄:Mn²⁺, BaSrMg.aAl₂O₃:Mn²⁺, and YBO₃:Tb³⁺.

The blue emitting phosphor may comprise at least one selected from the group consisting of BaMgAl₁₀O₁₇:Eu²⁺ and CaMgSi₂O₆:Eu²⁺.

The plasma display panel may further comprise a first dielectric layer covering the discharge electrode pairs; and a second dielectric layer covering the address electrodes.

The discharge electrodes may be arranged on the first substrate facing the second substrate, the discharge electrodes being covered with the first dielectric layer. The address electrodes may be arranged on the second substrate facing the first substrate, the address electrodes being covered with the second dielectric layer. The barrier rib structure may be interposed between the first and second dielectric layers.

The plasma display panel may further comprise a protective layer covering the first dielectric layer.

The plasma display panel may further comprise a discharge gas contained in the discharge cells.

### BRIEF DESCRIPTION OF THE DRAWINGS

The above and other features and advantages of the present embodiments will become more apparent by describing in detail exemplary embodiments thereof with reference to the attached drawings in which:

FIG. 1 is an exploded perspective view of a plasma display panel according to an embodiment; and

FIG. 2 is a cross-sectional view of the plasma display panel illustrated in FIG. 1, taken along line II-II of FIG. 1.

### DETAILED DESCRIPTION OF THE INVENTION

Hereinafter, exemplary embodiments will be described in detail with reference to the accompanying drawings.

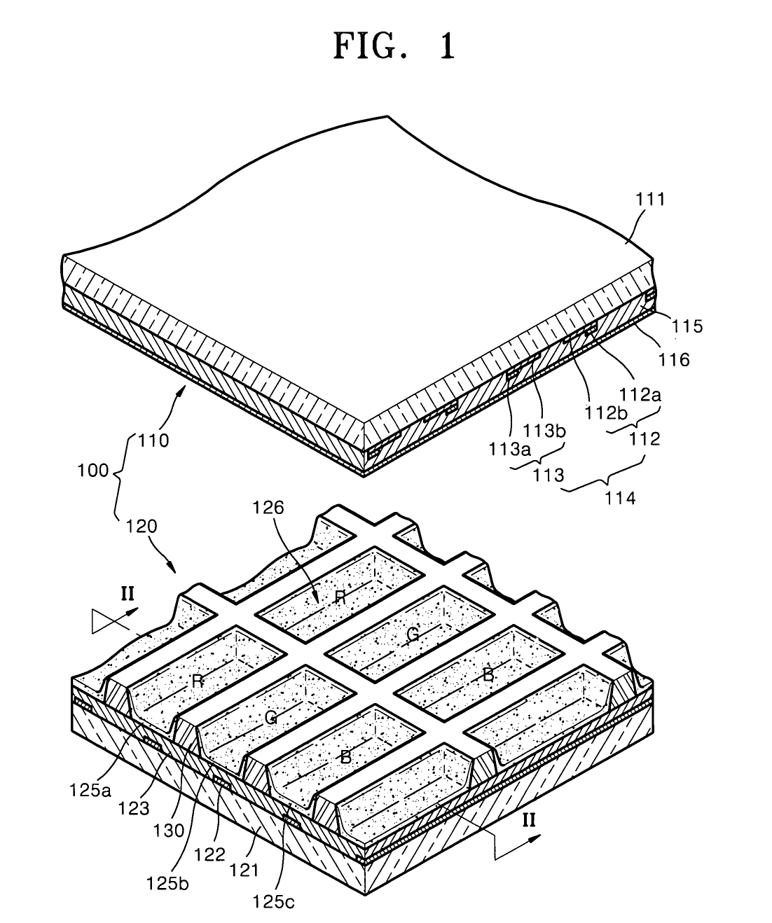

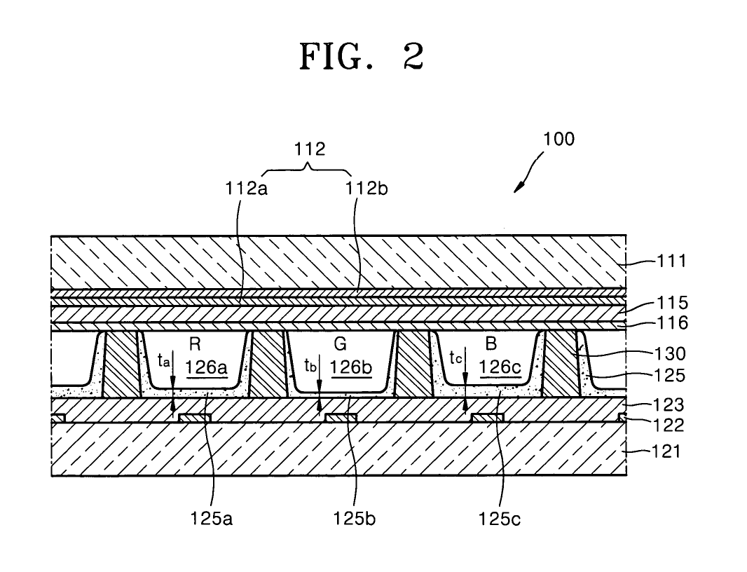

FIG. 1 is an exploded perspective view of a plasma display panel 100 according to an embodiment. FIG. 2 is a cross-sectional view of the plasma display panel 100, taken along line II-II of FIG. 1.

Referring to FIGS. 1 and 2, the plasma display panel 100 includes a first panel 110 and a second panel 120.

The first panel 110 includes a first substrate 111, a plurality of discharge electrodes 114 each having an X electrode 113 and an Y electrode 112 that extend over a plurality of discharge cells 126 and are supported by the first substrate 111, a first dielectric layer 115 covering the X electrode 113 and the Y electrode 112, and a protective layer 116 formed on the first dielectric layer 115.

The second panel 120 includes a second substrate 121 located to face the first substrate 111 at a predetermined distance from the first substrate 111, address electrodes 122 intersecting the discharge electrodes 114 in the discharge cells 126, and a second dielectric layer 123 covering the address electrodes 122.

A barrier rib structure 130 is located between the first and second substrates 111 and 121 to define the discharge cells 126 where a gas discharge occurs, and the inside of each of the discharge cells 126 is coated with a phosphor layer 125a, 125b or 125c and filled with a discharge gas.

The first and second panels 110 and 120 are supported by the barrier rib structure 130, and combined with each other by sealing the edges thereof via an adhesive such as frit.

The first substrate 111 may be formed of a transparent material having a predetermined strength, such as, for example, soda glass or transparent plastic.

The discharge electrodes 114 are arranged on the first substrate 111 through which visible rays generated in the discharge cells 126 pass. Thus, the X electrode 113 and the Y electrode 112 constituting each of the discharge electrodes 114 respectively include transparent electrodes 113b and 112b formed of a transparent material, such as an Indium Tin Oxide (ITO). The X electrode 113 and the Y electrode 112 may extend in parallel to each other. The transparent electrodes 113b and 112b have low electric conductance. Thus, to solve this problem, the X electrode 113 and the Y electrode 112 may further respectively include bus electrodes 113a and 112a formed lengthwise of a metal having good electric conductance, e.g., Ag, Cu, or Cr. The widths of the bus electrodes 113a and 112a may be respectively narrower than those of the X electrode 113 and the Y electrode 112 in order to improve the transmittivity of visible rays.

The discharge electrodes 114 may be formed by applying an electrode paste containing electrode materials over the first substrate 111 according to a screen printing method, and drying and baking the resultant structure. Otherwise, photolithography may be used to form the discharge electrodes 114 by etching an electrode paste containing a photosensitive photoresist by using photosensitive equipment.

The first dielectric layer 115 induces wall charges for the gas discharge in the discharge cells 126 by inducing charged particles via electric potentials applied to the discharge electrodes 114, and further protects the discharge electrodes 114.

The first dielectric layer 115 may be formed by applying a dielectric paste containing, for example, PbO or SiO₂ onto the first substrate 111 according to a screen printing method, and baking the resultant structure.

Also, the protective layer 116 may be formed by depositing a material containing MgO on the first dielectric layer 115. The protective layer 116 expedites a discharge by increasing discharge of secondary electrodes during the discharge, and protects the first dielectric layer 115 and the discharge electrodes 114 from collision with charged particles accelerated during the discharge.

The second substrate 121 may be formed of soda glass, similarly to the first substrate 111. However, since the second substrate 121 is not located in an optical path in which the visible rays generated in the discharge cells 126 propagate, it is not always needed to form the second substrate 121 of transparent glass. For example, the second substrate 121 may be formed of a plastic or a metal in order to reduce reactive power or the weight of the second substrate 121.

Unlike the discharge electrodes 114, since the address electrodes 122 are not located in the optical path, they need not be formed of a transparent material, such as ITO, and may be formed of Ag, Cu, Cr, or the like having good electric conductance.

The second dielectric layer 123 covering the address electrodes 122 is optional in the present embodiments. For example, if the phosphor layer 125 covers the address electrodes 122, the phosphor layer 125 may act as a dielectric layer. In this case, the dielectric layer 123 need not be additionally formed.

However, the second dielectric layer 123 is preferably formed to cover the address electrodes 123 in order to prevent the address electrodes 122 from being damaged during a process of manufacturing the barrier rib structure 130, and particularly, during a sandblasting process, and expedite a gas discharge.

The barrier rib structure 130 may be formed of a glass material containing elements, such as Pb, B, Si, Al, and O. Also, the barrier rib structure 130 may be formed of a filler containing, for example, ZrO₂, TiO₂, or Al₂O₃, and a pigment containing, for example, Cr, Cu, Co, Fe, or TiO₂.

The barrier rib structure 130 may be formed in a predetermined pattern by applying a paste for a barrier rib structure and performing the sandblasting process, a photolithography process, or an etching process on the resultant structure.

Although the shapes of the discharge cells 126 defined by the barrier rib structure 130 are illustrated as rectangles in FIG. 1, the shapes of the discharge cells 126 are not limited thereto. For example, the discharge cells 126 may have a polygonal shape, a circular shape, or a honey comb shape.

Also, the cross sections of the discharge cells 126 may have a stripe shape, not a closed shape. However, when the cross sections of the discharge cells 126 have a closed shape, it is possible to form each of the discharge electrodes 114 to encircle the discharge cell 126 in the barrier rib structure 130. Thus, it is possible to generate a gas discharge corresponding to three times the amount of gas discharge in the case when the cross section of the discharge cells has a stripe shape.

The phosphor layers 125 may be divided into red-emitting phosphor layers 125a, green-emitting phosphor layers 125b, and blue-emitting phosphor layers 125c to display a color image in the plasma display panel 100. Combinations of the red, green, and blue emitting phosphor layers 125a through 125c are disposed in the discharge cells 126 to form unit pixels for constituting a color image.

Each of the phosphor layers 125 is obtained by applying a phosphor paste, which is a mixture of red, green, and blue emitting phosphors, a solvent, and a binder, onto the space defined by the barrier rib structure 130 and the second substrate 121, and drying and baking the applied phosphor paste.

Referring to FIG. 2 the thicknesses tₐ, t_{b}, and t_{c} of the red, green, and blue emitting phosphor layers 125a through 125c, which are respectively formed in the discharge cells 126a through 126c, are preferably different from one another.

The thicknesses tₐ, t_{b}, and t_{c} of the red, green, and blue emitting phosphor layers 125a through 125c are more preferably controlled to be different from one another so that that the capacitances of the red, green, and blue emitting phosphor layers 125a through 125c are substantially the same.

Those of ordinary skill in the art can easily determine the thicknesses tₐ, t_{b}, and t_{c} of the red, green, and blue emitting phosphor layers 125a through 125c using the following relationship:

C=ε×(A/d) (1),

wherein C denotes the capacitance of phosphor layer, ε denotes the permittivity of phosphor layer, A denotes the area of phosphor layer, and d denotes the thickness of phosphor layer.

That is, when the permittivity of one of the red, green, and blue emitting phosphor layers 125a through 125c is greater than the permitivity of the other phosphor layers 125a through 125c, the thickness of this phosphor layer may be formed to be greater than the thicknesses of the other phosphor layers 125a through 125c in order to equalize the capacitances of the red, green, and blue emitting phosphor layers 125a through 125c.

A ratio of the thicknesses tₐ, t_{b}, and t_{c} of the red, green, and blue emitting phosphor layers 125a through 125c may vary according to materials constituting the red, green, and blue emitting phosphor layers 125a through 125c, and thus is not limited to a specific ratio.

For example, the ratio of the thicknesses tₐ, t_{b}, and t_{c} of the red, green, and blue emitting phosphor layers 125a through 125c may be 1:0.7 to 0.9:1.1 to 1.3, and more particularly, 1:0.83:1.22.

The types of the red, green, and blue emitting phosphor layers 125a through 125c are not limited. For example, Y₂O₃:Eu³⁺, Y(V;P)O₄:Eu³⁺ or (Y,Gd)BO₃:Eu³⁺ may be used as the red emitting phosphor, Zn₂SiO₄:Mn²⁺, BaSrMg.aAl₂O₃:Mn²⁺ or YBO₃:Tb³⁺ may be used as the green emitting phosphor, and BaMgAl₁₀O₁₇:Eu²⁺ or CaMgSi₂O₆:Eu²⁺ may be used as the blue emitting phosphor.

Combinations of the discharge cells 126 coated with the red, green, and blue emitting phosphor layers 125a through 125c are arranged to be adjacent to each other in the same direction, thus forming unit pixels which are basic units for constituting a color image. However, the arrangement of the discharge cells 126 according to the present embodiments is not limited to the same direction. If necessary, the widths or lengths of the discharge cells 126 may be different from one another or the discharge cells 126 may be arranged in a grating shape or a delta shape.

Also, the phosphor layers 125 may be formed in places other than the space defined by the second substrate 121 and the barrier rib structure 130 as illustrated in FIG. 1. For example, the phosphor layers 125 may be formed in various spaces, e.g., a space defined by the first substrate 111 and the barrier rib structure 130.

A discharge gas filled in each discharge cell 126 may be, for example, one of Ne gas, He gas, Ar gas, Xe gas, or a mixture thereof.

In this case, the discharge gas is generally charged under pressure lower than the atmospheric pressure. Thus, a compression force due to a vacuum pressure is applied onto the first and second panels 110 and 120 supported by the barrier rib structure 130.

A method of driving the plasma display panel 100 according to an embodiment and the function of the plasma display panel 100 according to the thicknesses of the phosphor layers 125 will now be described with reference to FIG. 2.

The plasma display panel 100 according to the present embodiments may be driven by using, for example, an ADS (address and display) driving method, an ALIS (alternate lighting of surfaces) driving method, or an AWD (address while display) driving method. Although various factors of the plasma display panel 100, such as the resolution and response speed thereof, may be changed according to the type of the driving method, the intrinsic characteristics of the present embodiments are not changed. Therefore, a method of driving the plasma display panel 100 according to an embodiment will be described with respect to the ADS driving method.

In general, a gas discharge is generated in each discharge cell 126 of the plasma display panel 100 in order to display an image. The gas discharge changes the state of wall charges or the amount of charged particles between the discharge cells, thus making it difficult to control a gas discharge occurring between the discharge cells 126 at a desired level.

In order to solve this problem, the wall charges can be removed from the discharge cells 126 and the amount of charged particles in the discharge cells 126 are equalized by applying a high voltage of a predetermined level or higher than the predetermined level to all of the discharge cells 126 to simultaneously generate a gas discharge in all the discharge cells 126. Such a process is referred to as a “reset discharge”.

The reset discharge is generally performed by applying a high-level ramp potential to all of the Y electrodes 112 and a ground potential to all of the address electrodes 122 and applying a bias potential to all of the X electrodes 113 for a predetermined length of time in order to generate a as discharge in all of the discharge cells 126.

After the reset discharge, an address discharge occurs in the discharge cells 126. In the address discharge, each of the discharge cells 126 that displays an image in response to an external image signal is selected as a discharge cell located at a point where one of the corresponding discharge electrodes 114, e.g., the Y electrode 112, intersects the address electrode 122. Then, a gas discharge is generated in the selected discharge cell 126 by respectively applying pulse voltages having different polarities to the Y electrode 112 and the address electrode 122 so as to allow charged particles to adhere to the sidewalls of the barrier rib structure in the discharge cell 126, thereby accumulating wall charges in the discharge cell 126.

After the address discharge, a high pulse potential is applied to the Y electrode 112 and a pulse potential lower than the high pulse potential is applied to the X electrode 113 so as to allow the wall charges accumulated in the discharge cell 126 to move due to the difference between electric potentials of the X electrode 113 and the Y electrode 112. In this case, the moving wall charges collide with the atoms of the discharge gas in the discharge cell 126, thereby generating a plasma discharge.

Ultraviolet rays generated by the plasma discharge excite the phosphor layers 125 formed in the discharge cells 126, and thus, the energy levels of the excited phosphor layers 125 are lowered to a low energy level to generate ultraviolet rays, thus displaying an image in the plasma display panel 100.

After the plasma discharge, when the difference between electric potentials of the discharge electrodes 114 is lower than a discharge voltage, a discharge is not further generated, and space charges and wall charges are formed in the discharge cells 126. In this case, when different pulse voltages are respectively, alternately applied to the discharge electrodes 114, the difference between the electric potentials of the discharge electrodes 114 reaches a firing voltage again, thereby generating a discharge. In this way, it is possible to maintain a discharge by respectively, alternately applying different pulse potentials to the discharge electrodes 114. In this case, such a discharge is referred to as a “sustain discharge” via which the gray level of the plasma display panel 100 is determined to display an image.

During an address discharge, if the thicknesses of the red, green and blue emitting phosphor layers 125a through 125c are the same, then the permittivity of phosphors thereof are different from one another, and thus, the capacitances of the red, green and blue emitting phosphor layers 125a through 125c are also different from one another.

Accordingly, firing voltages for the red, green and blue emitting phosphor layers 125a through 125c are different from one another. In this case, the highest firing voltage of the different firing voltages must be applied to the discharge cells 126 to generate a gas discharge in all the discharge cells 126.

However, when a driving voltage to be applied for an address discharge is higher, it is more difficult to stably drive the plasma display panel 100. This increases the price of an integrated circuit chip that controls an electrical signal to be applied to the Y electrode 112 and the address electrode 122, thus increasing the manufacturing costs of the plasma display panel 100. Also, an overdischarge occurs in the remaining discharge cells 126, excluding the discharge cell 126 to which the highest firing voltage is applied, and thus, an error may occur in a gas discharge since electric charges are consumed in the remaining discharge cells 126 without being accumulated therein.

In order to solve this problem, in the plasma display panel 100 according to an embodiment, the thicknesses of the red, green and blue emitting phosphor layers 125a through 125c are controlled to be different from one another in order to equalize the capacitances thereof.

A method of controlling the thicknesses of the red, green and blue emitting phosphor layers 125a through 125c to be different from one another has been described above. Also, a ratio of the thicknesses of the red, green and blue emitting phosphor layers 125a through 125c is not limited to a specific proportion, and may vary according to the materials for the red, green and blue emitting phosphor layers 125a through 125c.

As described above, when the thicknesses of the red, green and blue emitting phosphor layers 125a through 125c are controlled to equalize the capacitances thereof, a firing voltage required between the address electrode 122 and the Y electrode 112 of each discharge cell 126 including the red, green and blue emitting phosphor layers 125a through 125c, is the same, and the firing voltage is lower than in a conventional plasma display panel.

Accordingly, it is possible to prevent an overdischarge in the plasma display panel 100, which frequently occurs in discharge cells of a conventional plasma display panel. Further, it is possible to lower the power consumption to increase the efficiency of the plasma display panel 100, and reduce manufacturing costs of devices, such as driving circuit chips, thereby lowering the manufacturing costs of the plasma display panel 100.

The firing voltage applied to each discharge cell of a plasma display panel according to the present embodiments was measured and a conventional plasma display panel during an address discharge.

The conventional plasma display panel has a structure as illustrated in FIG. 1, and a discharge gas in each discharge cell thereof contains about 13% of Xe. The thicknesses of red, green, and blue phosphors applied onto the discharge cells are illustrated in Table 1. In Table 1, the thicknesses of the discharge cells are different from one another due to a dispersion process. A firing voltage was measured 200 times for each of red, green, and blue discharge cells. The measuring results are illustrated in Table 1.

TABLE 1

| | Thickness of Phosphor | A–Y Firing Voltage |
|---|---|---|
| Red Discharge Cell | 20 μm | 260–270 V |
| Green Discharge Cell | 22 μm | 272–285 V |
| Blue Discharge Cell | 25 μm | 257–270 V |

As illustrated in Table 1, a low firing voltage is applied to the blue discharge cell although the thickness thereof is high, and a comparatively high firing voltage is applied to the green discharge cell although the thickness thereof is small. In general, when a ramp wave is applied to the conventional plasma display panel for a weak address discharge, 70V are applied to an address electrode and −220 V are applied to a Y electrode in order to generate a weak discharge in all discharge cells. That is, the difference between the voltages applied to the address electrode and the Y electrode must be 290 V. In this case, an overdischarge is very likely to occur in the red and blue discharge cells, thereby causing electric charges to be consumed without being accumulated therein.

The plasma display panel according to the present embodiments, which was used in the measurement, is the same as the conventional plasma display panel except that the thicknesses of phosphor layers are significantly different from one another as illustrated in Table 2. In the measurement, a firing voltage was measured 200 times for each of red, green, and blue discharge cells. The measuring results are illustrated in Table 2.

TABLE 2

| | Thickness of Phosphor | A–Y Firing Voltage |
|---|---|---|
| Red Discharge Cell | 18 μm | 258–264 V |
| Green Discharge Cell | 15 μm | 260–265 V |
| Blue Discharge Cell | 22 μm | 255–264 V |

As illustrated in Table 2, the capacitances of the red, green, and blue discharge cells are equalized by controlling a ratio of the thicknesses thereof to a predetermined ratio. Therefore, it is possible to generate a weak address discharge in all the discharge cells when the difference between the voltages applied to an address electrode and an Y electrode is 256 V.

Table 2 reveals that a firing voltage of 256 V applied to the plasma display panel according to the present embodiments for an address discharge is significantly lower than a firing voltage of 290 V applied to the conventional plasma display panel, and the same firing voltage is required in each discharge cell.

The present embodiments have the following advantages. First, the capacitances of red, green, and blue discharge cells are equalized and a firing voltage for an address discharge is lower than in a conventional plasma display panel by controlling the thickness of phosphor layers applied onto the red, green, and blue discharge cells.

Second, since firing voltages applied to all the discharge cells are almost the same as described above, it is possible to prevent an overdischarge that frequently occurs in some discharge cells in the conventional plasma display panel, thereby minimizing an error in a gas discharge.

Third, a reduction in a firing voltage reduces not only power consumption thus improving the efficiency of a plasma display panel, but also the manufacturing price of devices, such as a driving circuit chip, thus lowering the manufacturing costs of the plasma display panel.

While these embodiments have been particularly shown and described with reference to exemplary embodiments thereof, it will be understood by those skilled in the art that various changes in form and details may be made therein without departing from the spirit and scope of the embodiments as defined by the appended claims.

What is claimed is:

1. A plasma display panel comprising:
a first substrate;
a second substrate facing the first substrate at a predetermined distance from the first substrate;
a barrier rib structure located between the first and second substrates configured to define discharge cells;
pairs of discharge electrodes each including an X electrode and an Y electrode which extend across the discharge cells;
address electrodes extending across the discharge cells that intersect the discharge electrodes in the discharge cells; and
phosphor layers applied onto the discharge cells and formed of one of red, green, and blue emitting phosphors,
wherein the thicknesses of the red, green, and blue phosphor layers which are respectively formed in the discharge cells are different from one another.

2. The plasma display panel of claim 1, wherein the capacitances of the red, green, and blue emitting phosphor layers are substantially the same.

3. The plasma display panel of claim 1, wherein, when the permittivity of one of the red, green, and blue emitting phosphor layers is greater than the permittivities of the others, the thickness of the red, green, or blue emitting phosphor layer which has the greatest permittivity is thicker than the thicknesses of the others.

4. The plasma display panel of claim 1, wherein the thicknesses of the red, green, and blue emitting phosphor layers are in a ratio of about 1:0.7 to about 0.9:1.1 to about 1.3.

5. The plasma display panel of claim 1, wherein the thicknesses of the red, green, and blue emitting phosphor layers are in a ratio of about 1:about 0.83:about 1.22 respectively.

6. The plasma display panel of claim 1, wherein the red emitting phosphor comprises at least one selected from the group consisting of Y₂O₃:Eu³⁺, Y(V,P)O₄:Eu³⁺ and (Y,Gd)BO₃:Eu³⁺.

7. The plasma display panel of claim 1, wherein the green emitting phosphor comprises at least one selected from the group consisting of Zn₂SiO₄:Mn²⁺, BaSrMg.aAl₂O₃:Mn²⁺, and YBO₃:Tb³⁺.

8. The plasma display panel of claim 1, wherein the blue emitting phosphor comprises at least one selected from the group consisting of BaMgAl₁₀O₁₇:Eu²⁺, and CaMgSi₂O₆:Eu²⁺.

9. The plasma display panel of claim 1, further comprising:
a first dielectric layer covering the discharge electrode pairs; and
a second dielectric layer covering the address electrodes.

10. The plasma display panel of claim 9, wherein the discharge electrodes are arranged on the first substrate facing the second substrate, and wherein the discharge electrodes are covered with the first dielectric layer, and
wherein the address electrodes are arranged on the second substrate facing the first substrate, and wherein the address electrodes are covered with the second dielectric layer, and
wherein the barrier rib structure is interposed between the first and second dielectric layers.

11. The plasma display panel of claim 9, further comprising a protective layer covering the first dielectric layer.

12. The plasma display panel of claim 1, further comprising a discharge gas contained in the discharge cells.

13. A plasma display panel comprising:
a first substrate;
a second substrate facing the first substrate at a predetermined distance from the first substrate;
a barrier rib structure located between the first and second substrates configured to define discharge cells;
pairs of discharge electrodes each including an X electrode and an Y electrode which extend across the discharge cells;
address electrodes extending across the discharge cells that intersect the discharge electrodes in the discharge cells; and
phosphor layers applied onto the discharge cells and formed of one of red, green, and blue emitting phosphors,
wherein the capacitances of all discharge cells are substantially the same.
